(19) United States
(12) Patent Application Publication
(10) Pub. No.: US 2011/0021064 A1
(43) Pub. Date: Jan. 27, 2011

(54) Connector Cover With Fastener

(75) Inventors: Shinsuke Shibata, Kanagawa (JP); Takao Ito, Kanagawa (JP); Hiromichi Komatsu, Kanagawa (JP)

Correspondence Address: MOLEX INCORPORATED, 2222 WELLINGTON COURT, LISLE, IL, 60532, US

(73) Assignee: MOLEX INCORPORATED, Lisle, IL (US)

(21) Appl. No.: 12/223,226

(22) PCT Filed: Jan. 26, 2007
(86) PCT No.: PCT/US2007/002187

§ 371 Date: Oct. 12, 2010

(30) Foreign Application Priority Data
Jan. 26, 2006 (JP) 2006-017481

(51) Int. Cl. H01R 13/58

(52) U.S. Cl. 439/470

(57) ABSTRACT

A connector having a housing for accommodating therein a plurality of terminals, each terminal being connected to electric wires extending from the housing, and a cover for covering a part of the electric wires that extends from the housing. The connector is configured such that the connector cover is provided with a linear element insertion aperture through which a linear tying element for tying the electric wires passes. The connector cover also has a plurality of split portions for being combined with each other. The electric wires are tied together and fixedly arranged by the linear element and the split portions are locked together.

### FIELD OF THE INVENTION

The present invention relates to a cover for a connector (hereinbelow referred to as a connector cover for simplicity sake).

### BACKGROUND OF THE INVENTION

Conventionally, an electric wire connector used with an automobile and the like, has a covering attached thereto by connecting it to a connector body for permitting coverage of a root portion of the electric wire, in order to prevent rain, washing water and the like, from entering the inside of the connector body (for example, Japanese Patent Application Laid-Open (kokai) No. 11-67329).

FIG. 6 is a perspective view showing a conventional connector cover.

In FIG. 6, a reference numeral 301 designates a connector housing which is made of synthetic resins to be formed as one part and has cylindrical electric wire insertion openings 302 formed in the back of the connector housing 301 for permitting an end of electric wire 303 to be inserted therethrough. Also, a terminal metal fitting 304 is fixed to an end of the electric wire 303, and a rubber plug 305 is mounted on a posterior position of the terminal metal fitting 304. When the end of the electric wire 303 is inserted in one of the electric wire insertion openings 302 from the rear of the connector housing 301 so that the terminal metal fitting 304 is disposed inside the connector housing 301, the rubber plug 305 seals up the electric wire insertion opening 302 and thus rain, washing water and the like, are prevented from entering the inside of the connector housing 301. Moreover, a cover-mounting flange 306 is formed around the electric wire insertion opening 302 in order to mount the connector cover to the cover-mounting flange 306.

Here, the connector cover includes a first half portion 311a and a second half portion 311b made of synthetic resins. Open ends of the first half portion 311a and the second half portion 311b, which are arranged to confront the connector housing 301 are provided with a mounting groove 312 for inserting the cover-mounting flange 306. Furthermore, on the opposite side of the mounting groove 312, a semicircular opening portion 316, which defines an electric wire passage hole for allowing the electric wire 303 to pass therethrough, is provided. Furthermore, the first half portion 311a and the second half portion 311b respectively have an engagement projection 313 and an engagement arm 315 having, formed therein, an engagement aperture 314 for allowing the engagement projection 313 to engage therein, as lock members.

The end of the electric wire 303 is inserted into one of the electric wire insertion openings 302 from the back of the connector housing 301. Then, the first half portion 311a and the second half portion 311b are mounted so as to sandwich the cover-mounting flange 306 from both sides while permitting the terminal metal fitting 304 to be placed in a predetermined position inside the connector housing 301, and are further locked by the lock members so that a connecting portion of the electric wire 303 to the connector housing 301 may be covered by the connector cover. An elastic holding portion 317 made of rubber having elasticity is mounted inside the first half portion 311a and the second half portion 311b, and the electric wire 303 is held by being sandwiched by a recessed portion 318 of the elastic holding portion 317.

However, in the conventional connector cover, the first half portion 311a and the second half portion 311b are locked with each other by the lock members, and therefore, the lock members might be broken when the connector cover is dismounted for inspection and the like. Furthermore, when a large number of electric wires 303 are incorporated, they are usually tied by using a tying band to be combined all together so that the electric wires 303 may be treated as a single cable. However, since the connector housing 301 is prepared for the connection of two electric wires 303, the above-mentioned connector cover does not fit for the combined electric wires 303 and is unable to appropriately hold the combined electric wires 303.

### SUMMARY OF THE INVENTION

The present invention has been made to solve the above problems encountered by the conventional connector cover, and has its object to provide a connector cover and a connector using same, in which by the use of a linear tying element for tying a plurality of electric wires together, the electric wires are fixedly mounted in a connector cover, and two half portions per se constituting the connector cover are locked together, whereby the cover connector and the cover using same may be comprised of only a few parts, repeatedly attached and detached without being broken, and is simple in its structure, at a low-cost, and easily-handled.

Therefore, the connector cover according to the present invention is provided for consisting a connector cover configured to be mounted on a housing of a connector to which electric wires are connected, and to cover a portion of the electric wires that extends from the housing, the connector cover including a plurality of split portions combined with one another, and a linear tying element which ties the electric wires while bringing the electric wires into a fixed condition, the linear tying element locking the split portions in a state of being combined with one another.

In accordance with another aspect of the present invention, the connector cover is configured in such a manner that the split portions are not detachable from the housing when the split portions are locked in the state of being combined with each other.

In accordance with a further aspect of the present invention, the connector cover is configured in such a manner that the split portions have insertion apertures for the linear element, and the linear tying element being arranged to pass through at least one linear tying element insertion aperture of each of the split portions.

In accordance with a still another aspect of the present invention, the connector cover is configured in such a manner that the split portions forms a tubular neck portion at an opposite end from the housing when the split portions are combined with each other, and a portion of the linear tying element is arranged to pass by an outer circumference of the neck portion.

In accordance with another aspect of the present invention, the connector cover is configured in such a manner that the neck portion is formed in a substantially square tube, and the linear element insertion apertures for the insertion of the linear tying element is formed in each corner of the square neck portion.

In accordance with a further aspect of the present invention, the connector cover is configured in such a manner that the split portions are a pair of members having an identical shape.

In accordance with another aspect of the present invention, the connector cover is configured in such a manner that ends of the split portions are slidably engaged with side ends of an electric wire insertion opening of the housing.

In accordance with the present invention, the connector is provided for constituting a connector, which has a housing accommodating therein a plurality of terminals, each being connected to each of electric wires extending from the housing, and a cover for the connector, i.e., a connector cover capable of covering a part of the electric wires that extends from the housing, the connector is configured in such a manner that the connector cover is provided with a linear element insertion aperture through which a linear tying element for tying the electric wires passes, and also has a plurality of split portions for being combined with each other, and that the electric wires are tied together and fixedly arranged by the linear element, and the split portions are locked in a state of being combined with each other.

In another aspect of the invention, the connector is configured in such a manner that the housing is provided with an engagement portion at a position thereof on a side confronting the connector cover, and the split portions are provided with a mounting portion at a position thereof on a side confronting the housing to be engaged with the engagement portion, the split portions being provided with, at an end thereof opposite to the housing, a neck portion which forms a tubular shape in a state where the split portions are combined with each other, and further in such a manner that at least one linear element insertion aperture is formed on the neck portion of each of the split portions, and the linear tying element is arranged to pass through at least one linear element insertion aperture of each of the split portions, a part of the linear tying element passing along an outer circumference of the neck portion.

According to the present invention, a connector cover and a connector using the same cover is capable of attaching a plurality of electric wires to the connector cover by using a linear tying element for tying the electric wires up, and also capable of bringing half portions constituting the connector cover into a state where they are locked together. Therefore, the connector cover and the connector using the same cover have only a few numbers of parts and can be simple in the configuration thereof. Further, they can be manufactured at a low cost and easy in its handling, and additionally are not broken even if they are repeatedly attached and detached during use thereof.

### BRIEF DESCRIPTION OF THE DRAWINGS

FIG. 1 is a perspective view showing a connector cover according to an embodiment of the present invention.

FIG. 2 is a perspective view showing the connector cover according to the embodiment of the present invention in a state before it is attached to a connector.

FIG. 3 is a view showing three sides of a half portion of the connector cover according to the embodiment of the present invention.

FIG. 4 is a perspective view showing the connector cover in a state during attaching according to the embodiment of the present invention.

FIG. 5 is a schematic view showing an attaching method of a tying band to the connector cover according to the embodiment of the present invention.

FIG. 6 is an exploded perspective view showing a conventional connector cover.

### DESCRIPTION OF THE PREFERRED EMBODIMENTS

An embodiment of the present invention will next be described in detail with reference to the drawings.

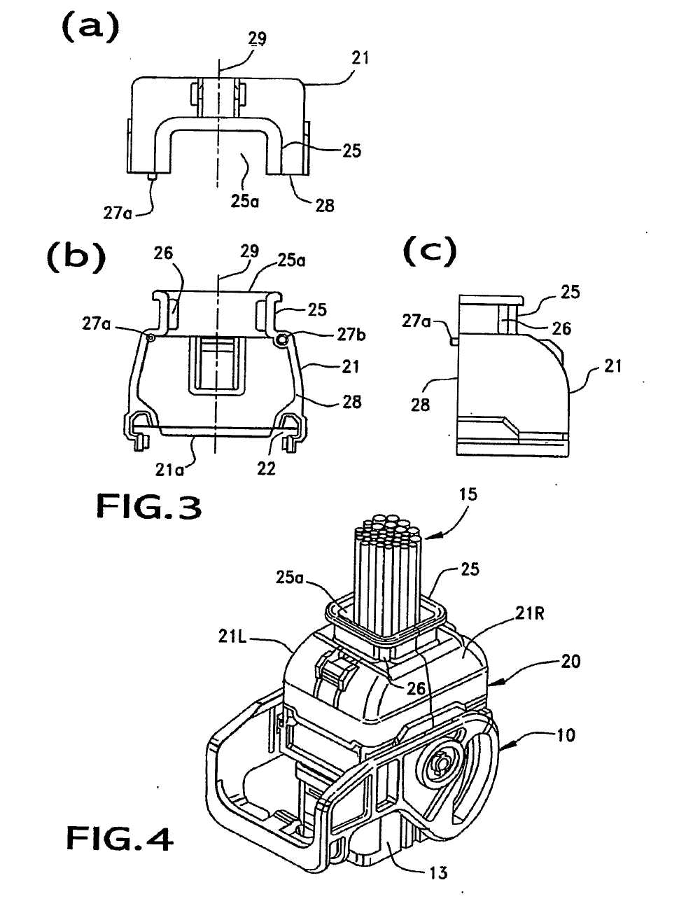

FIG. 2 is a perspective view showing a connector cover according to the embodiment of the present invention in a state thereof prior to being attached, and FIG. 3 is a view illustrating three sides of a half portion of the connector cover according to the embodiment of the present invention. In FIG. 3, (a) is a view illustrating a top plan view, (b) is a view illustrating a front elevation, and (c) is a view illustrating one side view.

In the respective figures, a reference numeral 10 designates a connector of the present embodiment, to which ends of a plurality of electric wires 15 are connected, and the connector 10 is brought into engagement with their corresponding electric wires or another corresponding connector which is connected to a circuit board (not shown), in order to electrically connect the electric wires 15 either to the corresponding electric wires or to the corresponding circuit board, which is connected to the corresponding other connector. The connector 10 is used for, for example, a water-proof connector for providing connection between a power supply and diverse lamps such as a brake lamp, of an auto vehicle such as a track, and which is engaged with the corresponding connector connected to the corresponding electric wires such as wire harnesses or the like. However, the connector 10 may be used for some other purpose.

The above-mentioned connector 10 includes a housing 13 made of insulating material such as synthetic resins and formed as one part, and includes a plurality of terminals (not shown) which are arranged inside the housing 13 and made of electrically conductive metal to which the ends of the respective electric wires 15 are connected. When the connector 10 is in a posture as shown in FIG. 2, an engaging surface for making engagement with the corresponding but separate connector faces downward, and in an opposite end of the engaging surface, an electric wire insertion opening 11 formed in the housing 13 faces upward. Thus, a cover member 20 as a connector cover for covering a root portion in the housing 13, from which the electric wires 15 connected to the connector 10 extends, is attached to the housing 13 so that rain, washing water, and the like do not wet a water-proof seal portion (not shown) formed inside the housing 13. Like the housing 13, the cover member 20 is made of insulating material such as synthetic resins.

In the present embodiment, it should be noted that expressions of direction such as up, down, left, right, front, rear, and the like, used for explaining a structure and operation of each part of the connector 10, the electric wires 15, and the cover members 20, are not absolute, but relative. These expressions are adequate when the connector 10, the electric wires 15 and the cover member 20 are in the posture as shown in the respective figures. If the postures thereof were changed, however, it is assumed that these expressions are to be changed according to the change in the postures thereof.

FIG. 2 shows the cover member 20 which is before being attached to the housing 13 of the connector 10, and the cover member 20 is divided into a right and a left member, respectively, that is, a first half portion 21R and a second half portion 21L which are split portions constituting the cover member 20. At this stage, the first half portion 21R and the second half portion 21L are a pair of members having the same shape, and as shown in FIG. 2, the first half portion 21R and the second half portion 21L are combined or locked together in a state of facing each other. It should be appreciated that hereinafter, the explanatory description of the first half portions 21R and the second half portion 21L is presented typically as to the half portions 21.

In the exemplary embodiment as shown in the figures, the electric wire insertion opening 11 has an almost rectangle shape, and engaging ribs 12 as attaching portions for attaching the half portions 21, are formed along a pair of side flanges of the electric wire insertion opening 11 which are facing each other in a manner in which the engaging ribs 12 are extended outside from a side wall of the housing 13. The engaging ribs 12 are separately formed into a plurality of pieces in relation to the moving directions of the half portions 21 shown in arrows. However, they may be integrally formed as one part in a continuous manner.

On the other hand, as shown in FIG. 3, engaging grooves 22 as attaching portions to be slidably engaged with a pair of opposed side flanges with respect to the above-mentioned electric wire insertion opening 11 and the engaging ribs 12 are formed at the lower end of the half portions 21. The engaging grooves 22 are engaged with the engaging rib 12 in a state in which the half portions 21 are attached to the housing 13 of the connector 10 so that the half portions 21 are prevented from moving upwards of FIG. 2, and detached and removed from the housing 13.

Furthermore, the half portion 21 is integrally formed as one unit having a symmetrical shape with respect to a center line 29, and engagement projection 27a and an engagement concave portion 27b are arranged on an engagement flat surface 28 for being engaged with the counterpart half portion 21. As shown in FIG. 2, when a pair of half portions 21 is brought into engagement to be combined together in a state where the respective half portions 21 facing each other, the engagement projection 27a is inserted in the engagement concave portion 27b of the counterpart half portion 21, and also, the engagement concave portion 27b permits the engagement projection 27a of the counterpart half portions 21 to insert therein. Therefore, the pair of half portions 21 can be engaged in position by the respective engagement projections 27a and the engagement concave portions 27b while taking a condition such that they are in registration with each other, to thereby precisely configure the cover member 20. Since the engagement projection 27a and the engagement concave portion 27b of the half portion 21 are arranged to be in symmetry with respect to the center line 29, in strictly speaking, the half portions 21 themselves are not symmetrical, respectively. However, the symmetrical arrangement of the engagement projection 27a and the engagement concave portion 27b enables the paired half portions 21 having the same shape to be engaged together in their condition facing each other.

Then, the cover member 20, configured by the pair of the engaged half portions 21, is tubular in its shape, and has openings on the top and the bottom thereof so that the electric wires 15 pass the inside thereof. Also, a lower opening 21a of the cover member 20 has a substantially rectangular shape which corresponds to the electric wire insertion opening 11 of the housing 13, and an inner circumference of the lower opening 21a is provided so as to closely surround an outer circumference of the electric wire insertion opening 11. Hence, rain, wash water and so on do not come into direct contact with a water-proof seal portion (not shown) formed inside the housing 13.

Further, each half portion 21 has a neck portion 25 formed on an upper end of a body thereof. The neck portion 25 is formed smaller than the body in a horizontal direction (the right and the left direction in FIG. 3(b)). Thus, an upper opening 25a of the cover member 20 which is formed on the uppermost end of the neck portion 25 has an opening area smaller than that of the lower opening 21a. That is, the upper opening 25a is narrowed in comparison with the lower opening 21a. Therefore, rain, wash water and so on do not come into direct contact with a water-proof seal portion (not shown) formed inside the housing 13. Like the lower opening 21a, the upper opening 25a also has an almost rectangular shape. Therefore, the neck portion 25 has a substantially rectangular tubular shape.

In the present embodiment, the neck portion 25 has a band aperture 26 formed as an aperture for insertion of a linear element, which allows inserting of a tying band 30 described later. In an example shown in this figure, the band aperture 26 is formed on each corner of the neck portion 25, that is, two band apertures 26 are formed in each of the paired half portions 21, and four band apertures 26 in total are formed in the cover member 20 as a whole. The number of the band apertures 26 and the location to be formed can be appropriately decided, and may be varied as required as long as one or more band aperture 26 is formed in each half portion 21. Furthermore, although the shape of the band aperture 26 has a substantially rectangle in an exemplary embodiment as shown in this figure (FIG. 3), this can be changed as necessary according to the cross-sectional shape and so on of the tying band 30 which passes therethrough.

Next, an explanation of operation carried out for mounting the connector 10 onto the cover member 20 is explained.

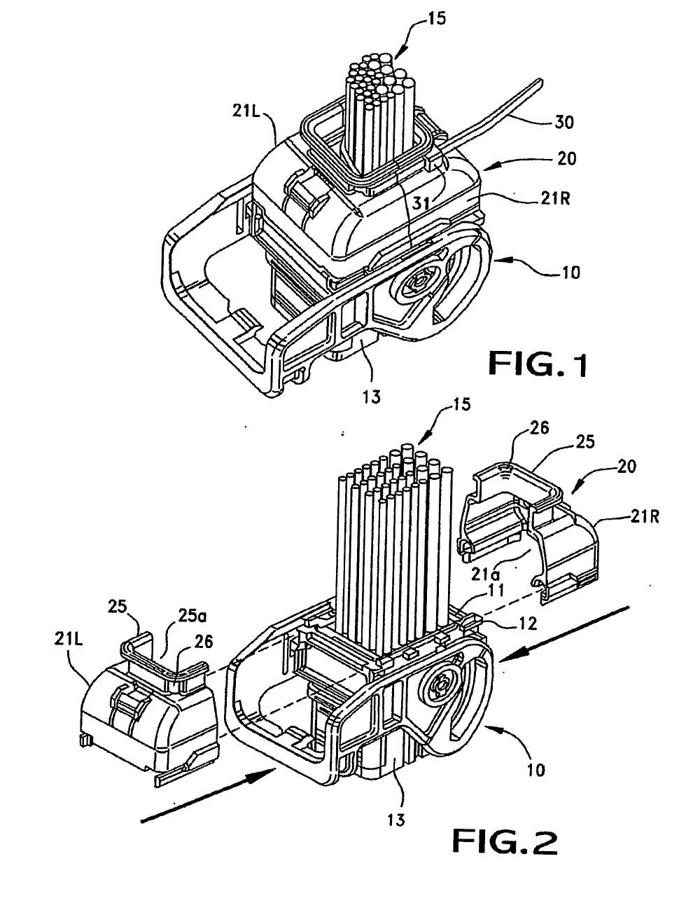

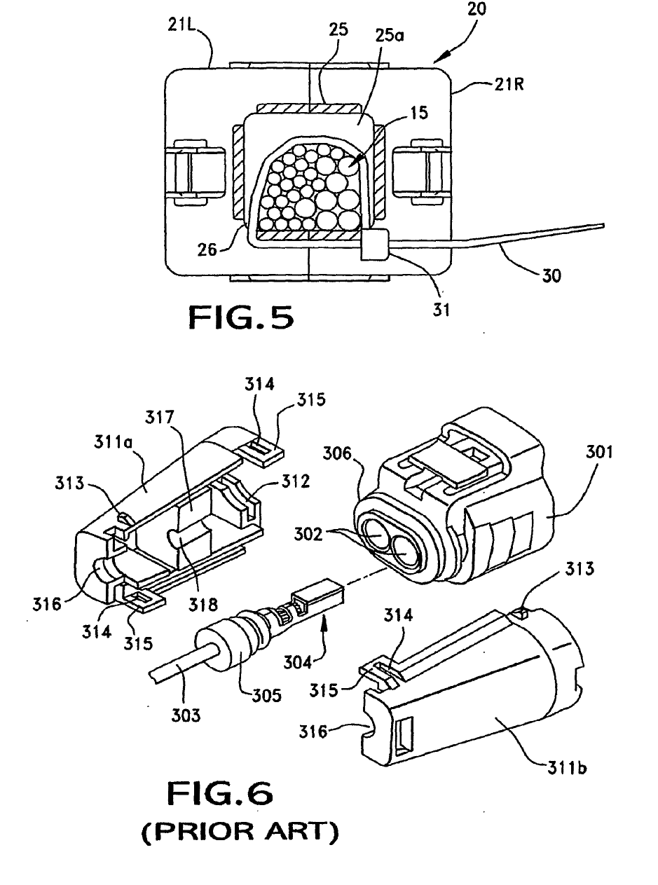

FIG. 1 is a perspective view showing a connector cover according to the embodiment of the present invention, FIG. 4 is a perspective view showing the connector cover in a process of being mounted according to the embodiment of the present invention, and FIG. 5 is a schematic view showing a method of attaching the tying band to the connector cover according to the embodiment of the present invention.

In this instance, the ends of the plurality of the electric wires 15 are inserted in the housing 13 through the electric wire insertion opening 11, and connected to the terminal of the connector 10 in advance. Then, an operator first holds the pair of the half portions 21 to be grasped by his or her fingers, and the like, and places them in position on both sides of the connector 10. In this instance, engagement flat surfaces 28 of both half portions 21 positioned on both sides of the connector 10 confront each other, and the location of the mounting grooves 22 corresponds to the location of the side flange of the electric wire insertion opening 11 and the mounting rib 12 of the housing 13.

Subsequently, the half portions 21 on both sides of the connector 10 are moved to the direction of arrows shown in FIG. 2. In this instance, the half portions 21 are moved so that the side flange of the electric wire insertion opening 11 and the mounting rib 12 are inserted into the mounting groove 22, and the mounting groove 22 slides along the side flange of the electric wire insertion opening 11 and the mounting rib 12. Then, the engagement flat surface 28 of each of the half portions 21 on both sides of the connector 10 are brought into engagement with each other, and the engagement projection 27a of one half portion 21 is inserted into the engagement concave portion 27b of the counterpart half portion 21. Hence, the half portions 21 on both sides of the connector 10 are engaged with each other in the mutually mated condition as shown in FIG. 4, in order to constitute the cover member 20. In this instance, the cover member 20 is neither displaced upwards from nor detached from the housing 13, since the side flange of the electric wire insertion opening 11 and the mounting rib 12 are inserted into the mounting groove 22, and the cover member 20 is engaged with the lower surface of the mounting rib 12.

In a condition shown in FIG. 4, the cover member 20 covers the root portion of the electric wires 15 connected to the connector 10 and the electric wire insertion opening 11 of the housing 13. Also, the electric wires 15 extend from the inside of the cover member 20 to the outside thereof through the upper opening 25a of the cover member 20.

Subsequently, the operator treats the tying band 30 namely, a tying linear element by using his or her fingers, and the like, so that the plurality of electric wires 15 are tied together by the tying band 30 to be one bundle in order to fix them to the cover member 20. In this instance, the tying band 30 is arranged to lie in a manner such that the tying band 30 surrounds around the plurality of electric wires 15 and a part of the neck portion 25. Hence, the electric wires 15 are securely fixed to the cover member 20.

In the present embodiment, as shown in FIGS. 1 and 5, the tying band 30 is a strip or string-like member formed as a unitary element, made of material such as synthetic resins having flexibility, and has a head portion 31 at one end thereof. At least one face of the tying band 30 has a plurality of saw-toothed convex portions, which extends in the orthogonal direction to the longitudinal direction of the tying band 30, is formed in parallel with the longitudinal direction. Also, an insertion bore is formed on the head portion 31 for allowing insertion of the tying band 30, and a band fixing projection for engaging with the convex portion is formed an inside face of the insertion bore. When the electric wires 15 are tied together, the tying band 30 is wound around the electric wires 15, and thereafter the opposite end of the head portion 31 of the tying band 30 is urged to passes through the above-mentioned insertion bore. Thereby, the tying band 30 forms a ring to surround the electric wires 15, as shown in FIG. 5. Thus, by moving the opposite end of the head portion 31 of the tying band 30 in a direction away from the head portion 31 (the rightward in FIG. 5), the ring surrounding the electric wires 15 is shrunk to thereby tightly tie the electric wires 15.

Also, it is desirable that the saw-toothed convex portions formed in the tying band 30 and the band fixing projection formed in the inside face of the insertion bore of the head portion 31 have a function to form a ratchet mechanism. Therefore, in an instance shown in FIG. 5, when the opposite end of the head portion 31 of the tying band 30 is moved away from the head portion 31, it is desirable that the convex portion and the band fixing projection be not engaged, and the opposite end can be moved freely. On the other hand, when the opposite end is moved closer to the head portion 31, it is desirable that the convex portion and the band fixing projection engages and movement of the opposite end be prohibited. This is achieved by adjusting the direction of angle of the convex portion and the direction of angle of the band fixing projection. Hence, it is not possible to enlarge the ring of the tying band 30 surrounding the electric wires 15, although the ring thereof can be shrunk, and therefore the operator can tightly tie the electric wires 15 easily and the tied electric wires 15 will not be loosened.

In this instance, the operator deals with the tying band 30 so that the tying band 30 runs to pass through the band aperture 26 of the neck portion 25 in order to fix the electric wires 15 to the cover members 20. In this instance, as shown in FIGS. 1 and 5, the tying band 30 is disposed to pass through the band aperture 26 formed each of the half portions 21 on both sides. Therefore, the half portions 21 on both sides of the connector 10 are locked by the tying band 30. Accordingly, the mutually engaged half portions 21 on both sides of the connector 10 are not detached from each other, nor is the cover member 20 separated apart.

The method of treating the tying band 30 shown in FIGS. 1 and 5 is merely an example. Any method is acceptable as long as the combining band 30 surrounds around the plurality of the electric wires 15 and a part of the neck portion 25, and the tying band 30 passes through at least one band aperture 26 formed in each of the half portions 21 on both sides.

As will be clear from the foregoing, according to the present embodiment, the cover member 20 includes two half portions 21, and the electric wires 15 are fixed by the tying band 30 for tying the electric wires 15. Further, the half portions 21 are locked in a state of being combined and engaged with each other. Therefore, a special lock mechanism for locking the half portions 21 together is not needed, the structure of the cover member 20 can be simplified, and the number of parts is reduced. Also, since any particular lock mechanism, which is often fragile, is not necessary, the cover member 20 cannot be broken even if it is repeatedly attached and detached, and thus the cost is reduced. Furthermore, the handling of the cover member 20 can be easier.

Furthermore, when the half portions 21 are locked in the state of being mutually combined together, they do not slide in arrow directions as shown in FIG. 2. Therefore, the half portions 21 are not detached from the housing 13. In this instance, the cover member 20 does not displace upwards from the housing 13, and is also not detached from the housing 13, since the side flange provided in the side of the electric wire insertion opening 11 and the mounting ribs 12 are fitted into the mounting groove 22, so that the mounting groove 22 is engaged with the mounting rib 12.

Furthermore, the half portions 21 have the band aperture 26, and the tying band 30 is disposed to run so that the tying band 30 passes through at lease one of the band apertures 26 of each of the half portions 21. Therefore, the half portions 21 are mutually locked together by the tying band 30, and the cover member 20 is not separated apart.

Furthermore, the half portions 21 are a pair of members having the shape identical to each other. Therefore, the cover member 20 can be configured by engaging the identical members with each other so as to face each other. Therefore, the configuration of the cover member 20 can be simple in the structure thereof, and has only a reduced number of parts. Furthermore, the half portions 21 can be produced by using one identical forming die, and thus the cost of the cover member 20 can be reduced.

One end of each half portion 21, that is, the lower end thereof is slidably engaged with the side flange of the electric wire insertion opening 11 of the housing 13.

Therefore, the cover member 20 can tightly surround the circumference of the electric wire insertion opening 11 and thus, rain, wash water, and so on do not come into direct contact with the water-proof seal portion (not shown) formed in the inside of the housing 13.

At this stage, it is to be noted that the tying band 30 described in the present embodiment is merely one example of the tying linear element, and any kind of linear tying element may be used as a linear tying element. For example, a mere strip or string-like member without a saw-toothed convex portion or a band fixing projection may be used as a linear tying element, and this may be made of synthetic resin materials, metallic materials, or the like.

Similarly, the half portions 21 are a mere example of the respective split portions. The split portions need not be of two half-split members, such as the half portions 21 which configure the cover member 20, but may be made from more than two portions.

Furthermore, in the present embodiment, a case in which the cover member 20 is fixed to the connector 10 manually by an operator has been described. Nevertheless, this operation may be done by an appropriate automatic device such as a robot hand, a manipulator and the like.

The present invention is not limited to the above embodiment, but may be diversely modified and varied. Thus, the modifications and variations are not excluded from the scope of protection of the present invention.

1. A connector cover adapted for being mounted on a housing of a connector to which electric wires are connected, and for covering a portion of the electric wires that extends from the housing, comprising:
a plurality of split portions mutually engaged with each other, and wherein
a linear tying element for tying the electric wires fixedly holds the electric wires while locking together the split portions.

2. The connector cover according to claim 1, wherein, when the split portions are locked together, the split portions are not detachable from the housing.

3. The connector cover according to claim 1, wherein the split portions have linear element insertion-apertures, respectively, and the linear tying element is disposed to run and pass through at least one linear element insertion-aperture of each of the split portions.

4. The connector cover according to claim 3, wherein the split portions forms a tubular neck portion at an opposite end thereof facing the housing when the split portions are locked together; and one portion of the linear tying element passes along an outer circumference of the neck portion.

5. The connector cover according to claim 4, wherein the neck portion is formed in a substantially rectangular tubular portion, and the linear element insertion-aperture is provided in each corner of the neck portion.

6. The connector cover according to claim 1, wherein the split portions comprise a pair of members, each having an identical shape.

7. The connector cover according to claim 6, wherein the split portions are provided with an end thereof, respectively, which is slidably engaged with a side edge arranged aside an electric wire insertion opening of the housing.

8. A connector having a housing which houses a plurality of terminals therein, each being connected to each of electric wires extending from the housing, and a connector cover for covering a portion of the electric wires, which extends from the housing, the connector cover being mounted on the housing wherein:
the connector cover is provided with a linear element insertion-aperture through which a linear tying element for tying the electric wires passes, and a plurality of split portions which are mutually engaged with one another; and
the linear tying element ties and fixedly holds the electric wires while locking the split portions in a state of being engaged with one another.

9. The connector according to claim 8, wherein:
(a) the housing includes engagement portions formed at an end thereof on the side thereof adjacent to the connector cover;
(b) the split portions comprise a mounting portion, respectively, capable of engaging with the engagement portion, and a neck portion which forms tubular shape in the state in which the split portions are engaged with each other;
(c) at least one said linear element insertion aperture is formed on the neck portion of each of the split portions; and
(d) the linear tying element is allowed to pass through at least one said linear element insertion aperture of the split portions, one part of the linear tying element being allowed to further pass along an outer circumference of the neck portion.
